(19) United States
(12) Patent Application Publication
(10) Pub. No.: US 2022/0389851 A1
(43) Pub. Date: Dec. 8, 2022

(54) SEGMENTED HONEYCOMB HEATER

(71) Applicant: CORNING INCORPORATED, Corning, NY (US)

(72) Inventor: Min Shen, Horseheads, NY (US)

(21) Appl. No.: 17/752,353

(22) Filed: May 24, 2022

Related U.S. Application Data
(60) Provisional application No. 63/195,872, filed on Jun. 2, 2021.

(51) Int. Cl. F01N 3/20; F01N 3/28

(52) U.S. Cl. CPC F01N 3/2026; F01N 3/2828; F01N 2240/16

(57) ABSTRACT

An exhaust gas heating system is provided, comprising a first end face, a second end face, a plurality of honeycomb segments, and a plurality of electrically nonconductive layers. Each honeycomb segment comprises an array of intersecting walls forming channels extending axially between the first end face and the second end face. The intersecting walls comprise an electrically conductive material. The heater further comprises a plurality of electrically nonconductive layers arranged between adjacent segments of the honeycomb segments. The arrays of intersecting walls of the honeycomb segments are electrically isolated from each other by the nonconductive layers. The exhaust gas heating system further comprises a coil wrapped around an external surface of the heater arranged between the first end face and the second end face. The exhaust gas heating system further comprises a DC to AC converter configured to supply the coil with an AC current.

### CROSS -REFERENCE TO RELATED APPLICATION

This application claims the benefit of priority under 35 U.S.C. § 119 of U.S. Provisional Application Ser. No. 63/195872 filed on Jun. 2, 2021, the content of which is relied upon and incorporated herein by reference in its entirety.

### FIELD OF THE DISCLOSURE

The present disclosure is directed generally to systems and methods for treating fluid streams, more particularly aftertreatment systems for treating engine exhaust, and in particular assemblies for heating a catalyst to improve catalytic performance.

### BACKGROUND

Catalytic converters or other catalyst-loaded aftertreatment components can be used to reduce toxins and pollutants in exhaust gas via chemical reactions between components of the exhaust gas with a catalyst carried by the catalytic converter. Initiation of these chemical reactions, which may be referred to as “light off,” requires sufficiently high temperatures. The heat for light off may be supplied from the heat of the exhaust being treated. As such, catalytic converter performance may be limited in the period immediately following the start of a vehicle's engine, also known as a “cold start,” during which the temperature of the catalyst is still below its light off temperature. As a result, cold start emissions can be a primary contributor for total tail pipe emission accumulation. Accordingly, there is a need in the art to reduce total emissions, such as by reducing cold start time or otherwise maintaining the catalyst above its light off temperature during engine operation.

### SUMMARY

This disclosure generally relates to a heater, an exhaust gas heating system, a method for heating exhaust gas, and a method for manufacturing an exhaust gas heating system.

Generally, in one aspect, a heater is provided. The heater comprises a first end face. The heater further comprises a second end face. The second end face is opposite to the first end face. According to an example, the heater is approximately between 4 and 10 inches axially long. According to a further example, the heater is approximately less than 1 inch in diameter.

The heater further comprises a plurality of honeycomb segments. Each honeycomb segment comprises an array of intersecting walls. The intersecting walls form channels. The channels extend axially between the first end face and the second end face. The intersecting walls comprise an electrically conductive material. According to an example, the plurality of channels are of substantially equal hydraulic diameter. According to a further example, each of the plurality of channels are square. According to an even further example, at least one of the intersecting walls is porous.

The heater further comprises a plurality of electrically nonconductive layers. Each of the plurality of electrically nonconductive layers is arranged between adjacent segments of the plurality of honeycomb segments. The arrays of intersecting walls of the plurality of honeycomb segments are electrically isolated from each other by the nonconductive layers. According to an example, at least one of the plurality of nonconductive layers is configured to mechanically affix the honeycomb segments of the adjacent segments. According to a further example, at least one of the plurality of nonconductive layers is a cement. According to an even further example, a conductivity of at least one of the plurality of nonconductive layers is less than 10−6 S/m. According to an even further example, at least one of the plurality of honeycomb segments comprises silicon carbide, such as metal-doped silicon carbide.

Generally, in another aspect, an exhaust gas heating system is provided. The exhaust gas heating system comprises the heater as described above. The exhaust gas heating system further comprises a coil. The coil comprises a plurality of turns wrapped around an external surface of the heater. The external surface is arranged between the first end face and the second end face. According to an example, the coil substantially covers the external surface of the heater.

According to an example, the exhaust gas heating system further comprises a DC to AC converter. The DC to AC converter is configured to receive a DC current. The DC to AC converter is further configured to supply the coil with an AC current. According to a further example, the AC current has a frequency greater than 10 kHz.

According to an example, the heater is operated at a power of at least 1 kW. According to a further example, the heater is heated to a temperature of at least 500° C.

Generally, in another aspect, a method of heating exhaust gas is provided. The method comprises supplying an AC current to a coil wrapped around a heater. The heater comprises a first end face a second end face, a plurality of honeycomb segments, and a plurality of electrically nonconductive layers. Each of the plurality of electrically nonconductive layers is arranged between adjacent segments of the plurality of honeycomb segments. Each honeycomb segment comprises an array of intersecting walls that form channels extending axially between the first end face and the second end face. The intersecting walls comprise electrically conductive material. The arrays of intersecting walls are electrically isolated from each other by the nonconductive layers.

The method further comprises receiving exhaust gas at the first end face of the heater. The method further comprises emitting exhaust gas from the second end face of the heater. The emitted exhaust gas has a higher temperature than the received exhaust gas. According to an example, the emitted exhaust gas has a temperature of greater than 250° F.

According to an example, the method further comprises receiving, by a DC to AC converter, a DC current from an electrical system of an automobile. The method further comprises generating, by the DC to AC converter, the AC current.

Generally, in another aspect, a method for manufacturing an exhaust gas heating system is provided. The method comprises extruding a plurality of honeycomb segments. Each honeycomb segment comprises an array of intersecting walls that form channels. The intersecting walls comprise an electrically conductive material.

The method further comprises affixing, via a nonconductive layer, the plurality of the honeycomb segments to each other to form a heater comprising a first end face, a second end face, and an external surface arranged between the first end face and the second end face. The channels of the honeycomb segments extend axially between the first end face and the second end face. The arrays of intersecting walls are electrically isolated from each other by the nonconductive layers.

The method further comprises wrapping a coil around the external surface of the heater. The coil substantially covers the external surface.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various examples.

FIGS. 1A and 1B are diagrams illustrating the skin effect in an unsegmented heater, according to an example.

FIG. 2 is a front view of a heater, according to an example.

FIG. 3 is a front view of a honeycomb segment of a heater, according to an example.

FIG. 4 is an isometric view of the honeycomb segments of a heater, according to an example.

FIG. 5 is an isometric view of an exhaust gas heating system, according to an example.

FIG. 6 is a further isometric view of an exhaust gas heating system, according to an example.

FIG. 7 is a heat map of an exhaust gas heating system with a segmented heater, according to an example.

FIG. 8 is a heat map of an exhaust gas heating system with an unsegmented heater, according to an example.

FIG. 9 is an electrical schematic of the exhaust gas heating system.

FIG. 10 is a method of heating exhaust gas, according to an example.

FIG. 11 is a method of manufacturing an exhaust gas system, according to an example.

### DETAILED DESCRIPTION

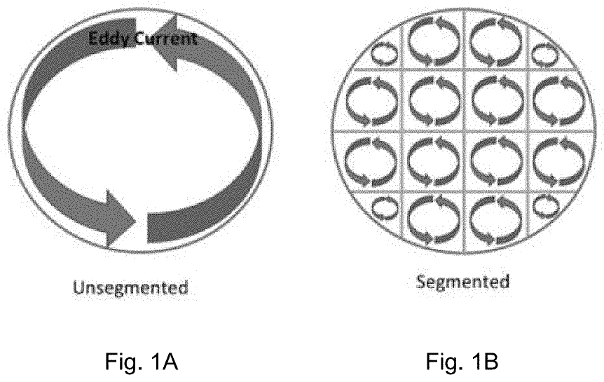

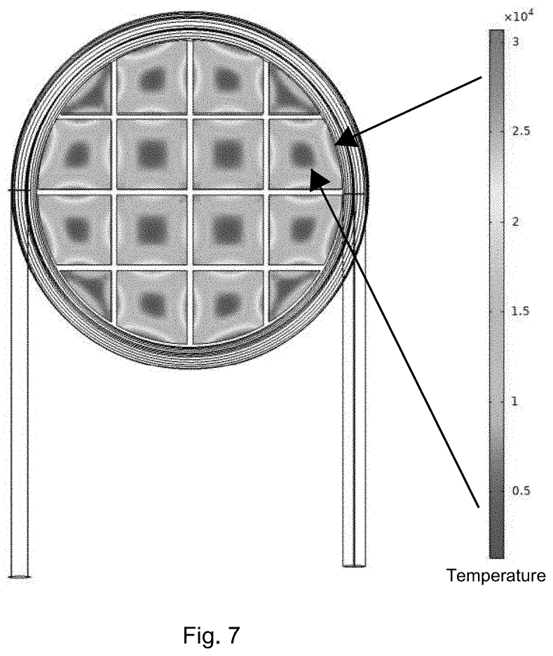

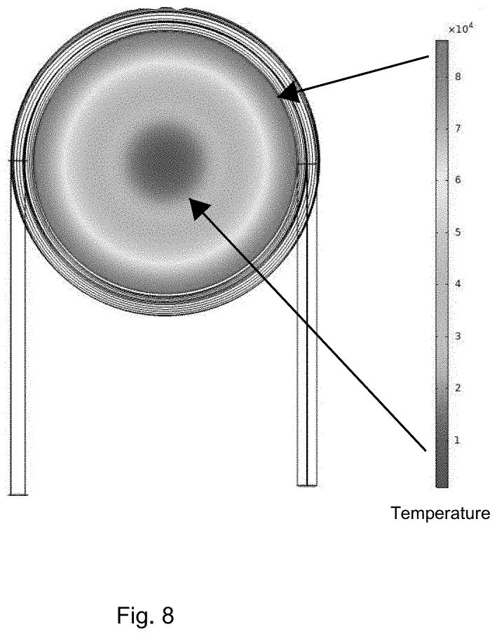

This disclosure generally relates to a heater, an exhaust gas heating system, a method for heating exhaust gas, and a method for manufacturing an exhaust gas heating system, e.g., for use in an automobile or other engine-containing device. These devices, systems, and methods may be useful to improve catalytic converter performance through upstream heating of exhaust gas, thus hastening light off, lowering cold start time, and significantly reducing both cold start emissions and total tail pipe emissions. This upstream heating is achieved using a heater including a plurality of honeycomb segments electrically isolated from each other by nonconductive layers. Each of the honeycomb segments also comprises a plurality of hollow cells or channels to permit exhaust gas to flow through the heater. The exhaust gas heating system also comprises an induction coil wrapped around the heater. The induction coil is configured to receive an AC current from a DC to AC converter electrically coupled to the electrical system of the automobile. The AC current applied to the induction coil generates eddy currents, and therefore heat, within the segments of the heater. The heater then heats exhaust gas flowing through the cells of the segments. The heated exhaust gas exits the heater and travels to downstream aspects of the exhaust system, such as the catalytic converter. Advantageously, the segmented nature of the heater (conductive segments separated by nonconductive bonding layers) causes the eddy currents to form and circulate within each segment, uniformly heating the entire heater, e.g., as shown and described below with respect to FIGS. 1B and 7. In an unsegmented heater, the eddy currents would flow through the periphery of the entire heater, which may only generate heat near its periphery, also known as the “skin effect,” e.g., as shown in FIGS. 1A and 8. The skin effect may lead to a significant variation in heating throughout the heater, and thus non-uniform heating of the exhaust gas passing through.

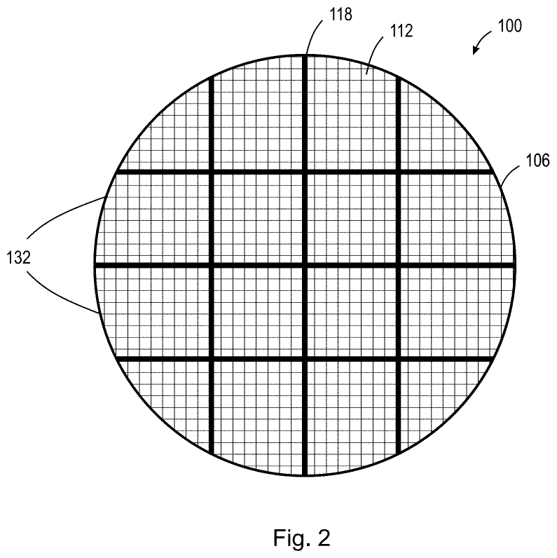

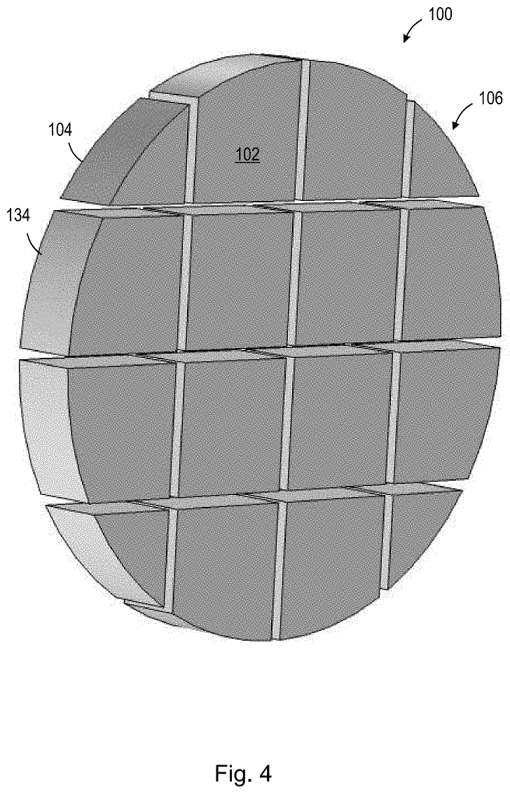

Generally, in one aspect, a heater 100 is provided. Example heaters 100 are illustrated in FIGS. 2 and 4. The heater 100 has a honeycomb configuration, comprising intersecting walls 124 that form a plurality of channels or cells 112 extending axially between opposite end faces 102 and 104. The heaters 100 are configured to increase the temperature of exhaust gas 128, e.g. generated by an engine, such as an automobile engine, passing through channels 112. In this way, the exhaust gas 128 received by the catalyst-carrying aftertreatment component, such as a catalytic converter or catalyst-loaded particulate filter, is sufficiently warmed to decrease cold start time and/or time before the light off of the catalyst, thereby reducing both cold start emissions and total tail pipe emissions. Accordingly, the heater 100 can be positioned upstream of the aforementioned aftertreatment component in an automobile's overall exhaust system. The heater 100 can also be used to heat gas in non-automotive applications. Accordingly, reference herein to “exhaust gas” refers to any fluid stream that is desired to be treated.

In some embodiment, and as illustrated in FIGS. 2 and 4, the heater 100 is cylindrical or disc-shaped. However, the heater 100 can have other shapes, such as a rectangular or polygonal prism. According to an example, the heater is less than or equal to 1 inch long in the axial direction, such as from 0.25 inches to 1 inch. However, in some embodiments, such as those in which the heater 100 itself is loaded with a catalyst, the heater 100 can have a longer axial length, such as at least 4 inches long, and thereby essentially replace a traditional catalyst substrate or catalyst-loaded particulate filter in an exhaust aftertreatment system. According to a further example, the heater 100 has a diameter of at least 3 inches, such as from 4 to 12 inches (or for non-round shapes, in the maximum cross-sectional dimension of the heater, perpendicular to the axial direction). In some embodiments, such as those in which the heater 100 is used in conjunction with a separate aftertreatment component (e.g., catalyst substrate or particulate filter), the heater 100 can have a diameter or other cross-sectional shape and/or dimension that approximately matches that of the aftertreatment component. The length and diameter of the heater 100 can be adjusted according to the constraints of the exhaust system utilizing the heater 100. For example, the length of the heater 100 can be less than the diameter of the heater 100. In a further example, the faces of heater 100 can be rectangular, ellipsoidal, trapezoidal, hexagonal, octagonal, or any other shape.

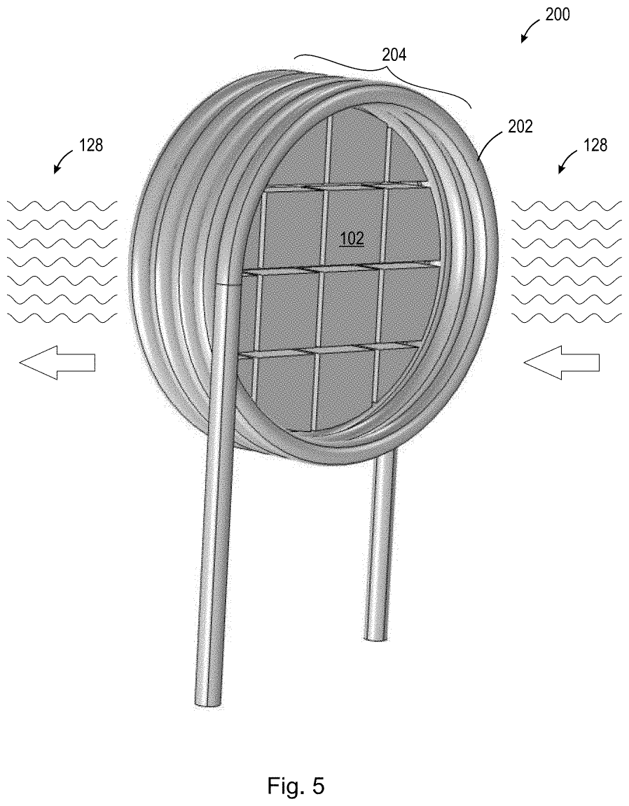

With reference to FIG. 4 (which does not show intersecting walls 124, but instead shows each of the segments 106 representatively as a single block), the first end face 102 can be arranged as an exhaust gas introduction face, and the second end face 104 can be arranged as an exhaust gas outlet face. In this way, and as illustrated in FIG. 5, the heater 100 receives exhaust gas 128 via the exhaust gas introduction face, and expels exhaust gas 128 via the exhaust gas outlet face. In some examples, the first end face 102 and the second end face 104 are interchangeable, depending on which face 102, 104 receives the exhaust gas 128.

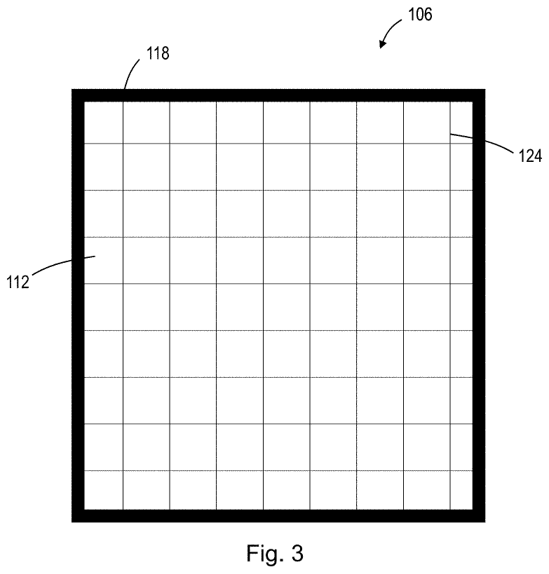

The heater 100 also comprises a plurality of honeycomb segments 106. Each of the honeycomb segments 106 comprises a separate array of the intersecting walls 124. FIG. 2 illustrates a heater 100 divided into sixteen honeycomb segments 106. However, the heater 106 can comprise any number of segments 106. A single honeycomb segment 106 is shown in FIG. 3. The walls 124 of the honeycomb segments 106 are made from an electrically conductive material to enable the flow of the eddy currents generated by electrical induction as described further herein. These eddy currents heat each individual honeycomb segment 106, as demonstrated in FIGS. 1B and 7. Heating each individual honeycomb segment 106, as opposed to the entire heater 100, avoids the uneven heating of the skin effect as demonstrated in FIGS. 1A and 8. According to an example, the material of the walls 124 of at least one of the plurality of honeycomb segments 106 is an electrically conductive ceramic material, such as silicon carbide. In some embodiments, the material of walls 124 is a porous material, such as a porous conductive ceramic material. Other varieties of conductive ceramics or other conductive materials, such as metals or metal-doped ceramics can be used. In a preferred example, all of the honeycomb segments 106 of the heater 100 are the same material. In some embodiments, the conductivity of the material of the walls 124 is at least about 10 S/m, such as from 10 S/m to about 100 S/, or about 60 S/m.

Each of the honeycomb segments 106 comprises a first side 108, e.g. an exhaust gas introduction side which forms a corresponding portion of the first end face 102 and thereby receives exhaust gas 128, and a second side 110, e.g. an exhaust gas outlet side 110 which forms a corresponding portion of the second end face 104 and thereby expels exhaust gas 128 after heating. Thus, the first sides 108 together form most of the first end face of the heater 100 and the second sides 110 together form most of the second end face 104 of the heater 100.

FIG. 3 shows the plurality of channels 112 in a single honeycomb segment 106. The channels 112 provide hollow passageways for the exhaust gas 128 to travel through, and be heated by, the walls 124 of the segments 106 of the heater 100. As shown in FIG. 3, the channels 112 are square. In other examples, the channels 112 are hexagonal, circular, octagonal, triangular, or another shape. According to an example, the plurality of channels 112 are of substantially equal size, shape, volume, and/or hydraulic diameter.

The heater 100 also comprises a plurality of nonconductive layers 118. As depicted in FIG. 2, each of the plurality of nonconductive layers 118 is arranged between each pair 132 of adjacent segments of the plurality of honeycomb segments 106. The nonconductive layers 118 are configured to electrically isolate the honeycomb segments 106 of the adjacent segment pair 132. Electrically isolating the honeycomb segments 106 prevents the skin effect shown in FIGS. 1A and 8 by creating individual eddy currents in each of the segments 106 as shown in FIGS. 1B and 7. According to a further example, the nonconductive layers are configured to mechanically affix the honeycomb segments 106 of the adjacent segment pairs 132. According to an example, at least one of the plurality of nonconductive layers 118 is a cement. The nonconductive layers 118 can be any other material configured to electrically isolate and/or mechanically affix honeycomb segments 106. According to a further example, the conductivity of the material of the nonconductive layers is less than 10⁻⁶ S/m.

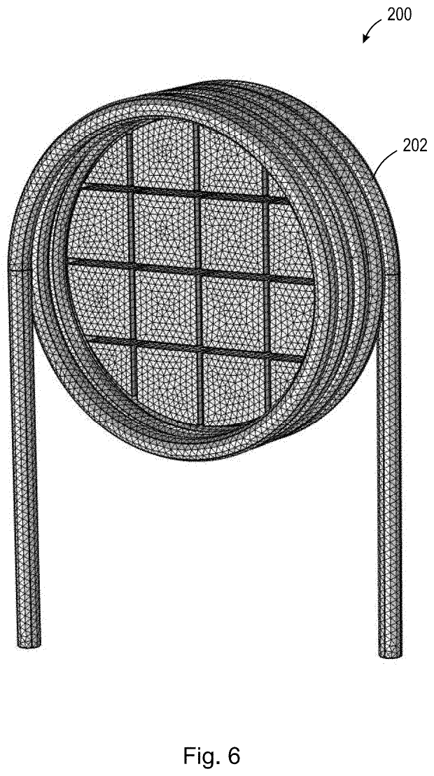

Generally, and with reference to FIGS. 5 and 6, in another aspect, an exhaust gas heating system 200 is provided. The exhaust gas heating system 200 comprises the heater 100 as described above. The exhaust gas heating system 200 further comprises a coil 202. The coil 202 can be copper, aluminum, or another metal of high conductivity. The coil comprises 202 a plurality of turns 204 wrapped around an external surface 134 of the heater 100. As depicted in FIG. 4, the external surface 134 is arranged between the first end face 102 and the second end face 104 of the heater 100. According to an example, the coil 102 substantially covers the external surface 134 of the heater 100. As shown in FIGS. 5 and 6, the coil 202 can have five turns. The number of turns 204 depends on a number of factors, including the desired amplitude of the generated eddy currents. According to a further example, the coil 202 can have five to ten turns.

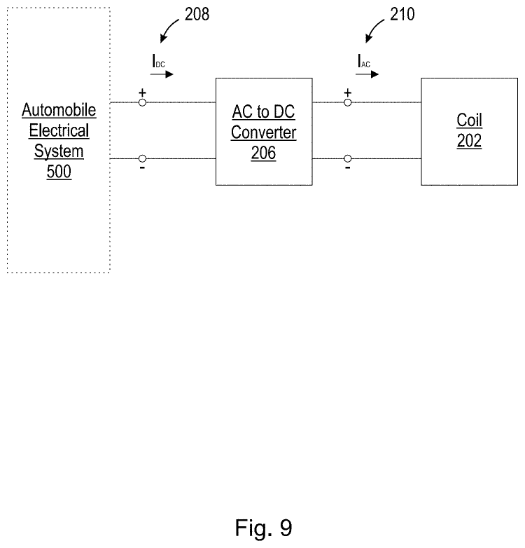

According to an example, and with reference to FIG. 9, the exhaust gas heating system 200 further comprises a DC to AC converter 206. According to an example, the DC to AC converter 206 is a power inverter. Automobile electrical systems 500 are typically DC systems. As the coil 202 requires an AC current 210 to generate eddy currents within heater 100, the exhaust gas heating system 200 requires a device and/or circuit to convert DC current 208 from the automobile electrical system 500 to an AC current 210.

As shown in FIG. 9, the automobile electrical system 500 generates a DC current 208, I_{DC}. The AC to DC converter 206 receives IDC, and converts it to an AC current, I_{AC}. I_{AC} is then provided to coil 202 wrapped around heater 100. The I_{AC} flowing through coil 202 generates eddy currents within each honeycomb segment 106 of the heater 100 via induction. These eddy currents generate heat within each segment 106 of the heater 100, thus heating exhaust gas 128 passing through the channels 112 of the segments 106.

According to a further example, the AC current 210 has a frequency greater than 10 kHz. In some embodiments, heater 100 is heated to a temperature of at least 500° C., at least 600° C., at least 700° C., at least 800° C., at least 900° C., or even at least 1000° C., such as up to at least 1200° C., up to 1100° C., or up to 1000° C., or any range including those endpoints. In some embodiments, the heater 100 is operated at a power of 1 kW to 10 kW, such as from about 2 kW to about 6 kW. The conductive material of the segments 106 can be selected to have a conductivity that provides the target power and target temperature based on the dimensions of the segments 106.

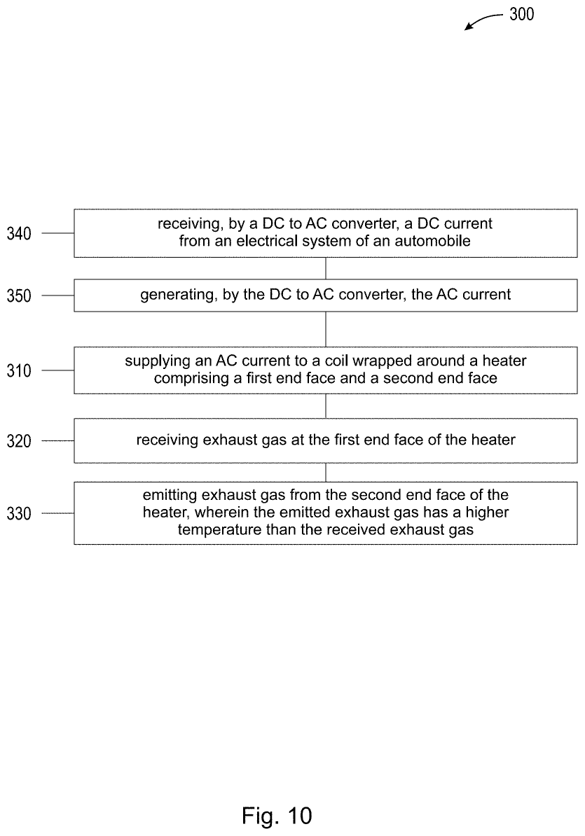

Generally, in another aspect, and with reference to FIG. 10, a method of heating exhaust gas 300 is provided. The method 300 comprises supplying 310 an AC current to a coil wrapped around a heater. The heater comprises a first end face, a second end face, a plurality of honeycomb segments, and a plurality of electrically nonconductive layers. Each of the plurality of electrically nonconductive layers is arranged between adjacent segments of the plurality of honeycomb segments. Each honeycomb segment comprises an array of intersecting walls that form channels extending axially between the first end face and the second end face. The intersecting walls comprise electrically conductive material. The arrays of intersecting walls are electrically isolated from each other by the nonconductive layers.

The method 300 further comprises receiving 320 exhaust gas at the first end face of the heater. The method 300 further comprises emitting 330 exhaust gas from the second end face of the heater. The emitted exhaust gas has a higher temperature than the received exhaust gas. According to an example, the emitted exhaust gas has a temperature of greater than 250° F.

According to an example, the method 300 further comprises receiving 340, by a DC to AC converter, a DC current from an electrical system of an automobile. The method 300 further comprises generating 350, by the DC to AC converter, the AC current.

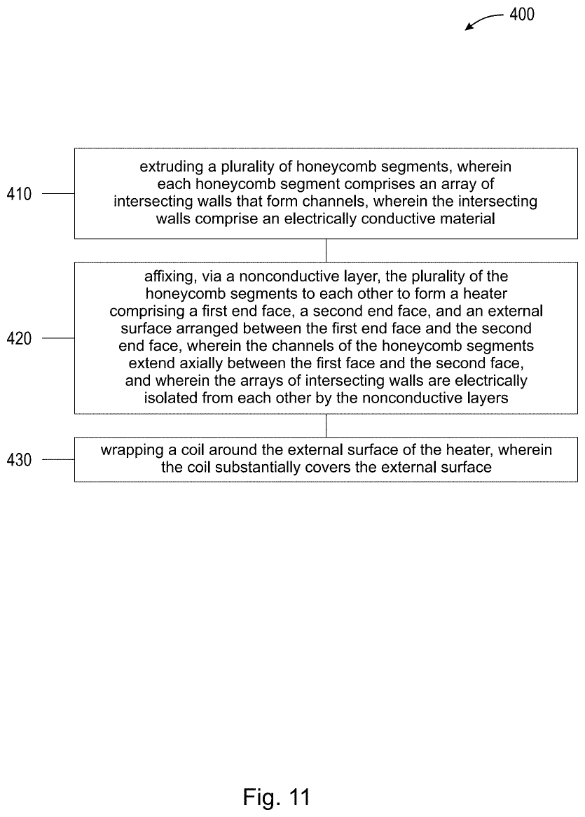

Generally, in another aspect, and with reference to FIG. 11, a method for manufacturing an exhaust gas heating system 400 is provided. The method 400 comprises extruding 410 a plurality of honeycomb segments. Each honeycomb segment comprises an array of intersecting walls that form channels. The intersecting walls comprise an electrically conductive material.

The method 400 further comprises affixing 420, via a nonconductive layer, the plurality of the honeycomb segments to each other to form a heater comprising a first end face, a second end face, and an external surface arranged between the first end face and the second end face. The channels of the honeycomb segments extend axially between the first end face and the second end face. The arrays of intersecting walls are electrically isolated from each other by the nonconductive layers.

The method 400 further comprises wrapping 430 a coil around the external surface of the heater. The coil substantially covers the external surface.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A heater, comprising:
a first end face;
a second end face opposite to the first end face;
a plurality of honeycomb segments, wherein each honeycomb segment comprises:
an array of intersecting walls that form channels extending axially between the first end face and the second end face, wherein the intersecting walls comprise an electrically conductive material; and
a plurality of electrically nonconductive layers, wherein each of the plurality of electrically nonconductive layers is arranged between adjacent segments of the plurality of honeycomb segments, and wherein the arrays of intersecting walls of the plurality of honeycomb segments are electrically isolated from each other by the nonconductive layers.

2. The heater of claim 1, wherein at least one of the plurality of nonconductive layers is configured to mechanically affix the honeycomb segments of the adjacent segments.

3. The heater of claim 1, wherein at least one of the plurality of nonconductive layers is cement.

4. The heater of claim 1, wherein a conductivity of at least one of the plurality of nonconductive layers is less than 10⁻⁶ S/m.

5. The heater of claim 1, wherein at least one of the plurality of honeycomb segments comprises silicon carbide.

6. The heater of claim 1, wherein the heater is approximately between 4 and 10 inches axially long.

7. The heater of claim 1, wherein the heater is approximately less than 1 inch in diameter.

8. The heater of claim 1, wherein each of the plurality of channels are of substantially equal hydraulic diameter.

9. The heater of claim 1, wherein each of the plurality of channels are square.

10. The heater of claim 1, wherein at least one of the intersecting walls is porous.

11. An exhaust gas heating system, comprising:
the heater of claim 1; and
a coil comprising a plurality of turns wrapped around an external surface of the heater, wherein the external surface is arranged between the first end face and the second end face.

12. The exhaust gas heating system of claim 11, further comprising a DC to AC converter, the DC to AC converter configured to receive a DC current and supply the coil with an AC current.

13. The exhaust gas heating system of claim 12, wherein the AC current has a frequency greater than 10 kHz.

14. The exhaust gas heating system of claim 11, wherein the coil substantially covers the external surface of the heater.

15. The exhaust gas heating system of claim 11, wherein the heater is operated at a power of at least 1 kW.

16. The exhaust gas heating system of claim 11, wherein the heater is heated to a temperature of at least 500° C.

17. A method of heating exhaust gas, comprising:
supplying an AC current to a coil wrapped around a heater comprising a first end face, a second end face, a plurality of honeycomb segments, and a plurality of electrically nonconductive layers, wherein each of the plurality of electrically nonconductive layers is arranged between adjacent segments of the plurality of honeycomb segments, wherein each honeycomb segment comprises an array of intersecting walls that form channels extending axially between the first end face and the second end face, wherein the intersecting walls comprise electrically conductive material, and wherein the arrays of intersecting walls are electrically isolated from each other by the nonconductive layers;
receiving exhaust gas at the first end face of the heater; and
emitting exhaust gas from the second end face of the heater, wherein the emitted exhaust gas has a higher temperature than the received exhaust gas.

18. The method of claim 17, further comprising:
receiving, by a DC to AC converter, a DC current from an electrical system of an automobile; and
generating, by the DC to AC converter, the AC current.

19. A method for manufacturing an exhaust gas heating system, comprising:
extruding a plurality of honeycomb segments, wherein each honeycomb segment comprises an array of intersecting walls that form channels, wherein the intersecting walls comprise an electrically conductive material;
affixing, via a nonconductive layer, the plurality of the honeycomb segments to each other to form a heater comprising a first end face, a second end face, and an external surface arranged between the first end face and the second end face, wherein the channels of the honeycomb segments extend axially between the first end face and the second end face, and wherein the arrays of intersecting walls are electrically isolated from each other by the nonconductive layers; and
wrapping a coil around the external surface of the heater, wherein the coil substantially covers the external surface.
